(19) United States
(12) Patent Application Publication
(10) Pub. No.: US 2004/0247152 A1
(43) Pub. Date: Dec. 9, 2004

(54) Production of non-planar membranes for electroacoustic convertes

(76) Inventors: Horst Greb, Marina Del Rey, CA (US); Roland Geduldig, Buettelborn (DE); Michael Deitrich, Damstadt (DE); Torsten Jahn, Dieburg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/484,781

(22) PCT Filed: Jul. 9, 2002
(86) PCT No.: PCT/EP02/07603

(30) Foreign Application Priority Data
Jul. 25, 2001 (DE) 10135414.2

(51) Int. Cl. H04R 1/00; H04R 9/06; H04R 11/02; H04R 31/00

(52) U.S. Cl. 381/423; 381/424; 381/426; 381/430; 29/594

(57) ABSTRACT

The present invention relates to a process for producing a shaped diaphragm for electroacoustic transducers which comprises a core layer comprising poly(meth)acrylimide foam and at least one covering layer, which is characterized in that

a) the covering layer is laminated with the core layer under a pressure of <0.3 MPa and at a temperature of ≧160° C., and

b) the resulting composite is subsequently molded at a pressure of ≧0.3 MPa and a temperature of ≧160° C. using a cold mold which is at a temperature of less than 100° C. and at least the side of the core layer which is in contact with the covering layer is compacted at the same time.

The diaphragms produced according to the invention display excellent strength and, in particular, the covering layers have a very high peel strength.

The present invention relates to a process for producing shaped diaphragms for electroacoustic transducers, which comprise a core layer comprising poly(meth)acrylimide foam and have at least one covering layer, and to diaphragms for electroacoustic transducers.

Electroacoustic transducers or loudspeakers are devices which are able to convert electric alternating currents in the sound frequency range into audible sound. These devices are widely known in the prior art and are described, for example, in U.S. Pat. No. 4,928,312, DE-A 30 36 876 and DE-A 22 25 710.

The production of these loudspeakers requires diaphragms which have to meet numerous conditions. Thus, the weight of the diaphragm should be as low as possible, while its strength should meet relatively high requirements so that the diaphragms behave as completely stiff cylinders even at high frequencies.

Thus, for example, EP-A-0 087 177 describes a diaphragm which comprises a layer of poly(meth)acrylimide foam. In this document, it is stated that the poly(meth)acrylimide-containing layer can be provided with a covering layer. This covering layer is applied at room temperature by means of adhesive to ensure that the density of the core layer remains as low as possible. According to EP-A-0 087 277, the quotient of density and modulus of elasticity should be as small as possible, since this factor is a measure of the quality of the diaphragm.

Loudspeaker diaphragms can be provided with covering layers for many reasons. These include, inter alia, increasing the strength of the diaphragm, or aesthetic reasons. However, the process proposed in EP-A-0 087 177 for producing diaphragms for acoustic transducers which comprise a core layer comprising poly(meth)acrylimide foam and at least one covering layer is complicated since it is a two-stage process. Furthermore, it is suitable only for covering layers which have a fibrous structure, since volatilization of solvent from the composite of core layer and covering layer is only ensured by these.

Furthermore, it has been found that the decoration films easily become detached from the core layer on prolonged use if they have been applied to a particularly smooth poly(meth)acrylimide layer. Here, it has to be remembered that although the diaphragm should be configured as a stiff cylinder, this aim can be achieved only incompletely and vibrations and deformations within the diaphragm are unavoidable. These vibrations can lead to detachment occurring over a prolonged period of time.

A first approach to solving these problems is disclosed in DE 199 25 787. It describes a process for producing a diaphragm for electroacoustic transducers which comprise a core layer comprising a poly(meth)acrylimide foam and at least one covering layer, for example films comprising polypropylene, polyester, polyamide, polyurethane, polyvinyl chloride, polymethyl (meth)acrylate and/or metal, for example aluminum, mats or sheets comprising glass fibers, carbon fibers and/or aramid fibers, in which the covering layer is laminated with the core layer under a pressure of ≧0.4 MPa and at a temperature of ≧160° C., at least the side of the core layer which is in contact with the covering layer is at the same time compacted and the composite obtained is subsequently cooled to a temperature below 80° C. before the pressure is reduced to ambient pressure. The process can be carried out as a single-step process. The diaphragms produced in this way display excellent strength and, in particular, the covering layers have a very high peel strength.

However, the process described in DE 199 25 787 for producing shaped diaphragms has only limited usefulness since the achievable cycle times which are the inevitable result of the time required for pressing the core layer together with the covering layer would be from 45 to 60 minutes and therefore much too high and not economically acceptable.

In view of the prior art reported and discussed here, it is an object of the present invention to provide a process for producing shaped diaphragms for electroacoustic transducers which comprise a core layer comprising poly(meth)acrylimide foam and at least one covering layer. The process should be able to be carried out in a simple way and allow short cycle times.

A further object of the invention is to provide shaped diaphragms for electroacoustic transducers which comprise a core layer comprising poly(meth)acrylimide foam and at least one covering layer, in which diaphragms the abovementioned detachment problems of the covering layer are reduced or eliminated.

These objects and further objects which are not explicitly mentioned but can readily be derived or deduced from the relationships discussed here by way of introduction are achieved by a process for producing a shaped diaphragm for electroacoustic transducers which comprises a core layer comprising poly(meth)acrylimide foam and at least one covering layer and has all the features of claim 1. Preferred embodiments of the process of the invention are claimed in the subordinate claims dependent on claim 1. The independent product claim claims the shaped diaphragm of the invention for electroacoustic transducers which comprises a core layer comprising poly(meth)acrylimide foam and at least one covering layer. Advantageous modifications of the shaped diaphragm are described in the subordinate claims dependent on the independent product claim. A particularly preferred inventive use of the shaped diaphragm for electroacoustic transducers which comprises a core layer comprising poly(meth)acrylimide foam and at least one covering layer is indicated in the use claim.

Production of a shaped diaphragm for electroacoustic transducers which comprises a core layer comprising poly(meth)acrylimide foam and at least one covering layer by

a) laminating the covering layer with the core layer under a pressure of ≦0.3 MPa and at a temperature of ≧160° C. and subsequently

b) molding the resulting composite at a pressure of ≧0.3 MPa and a temperature of ≧160° C. using a cold mold which is at a temperature of less than 100° C. and at the same time compacting at least the side of the core layer which is in contact with the covering layer,

makes it possible, in a not readily foreseeable manner, to provide a process for producing a shaped diaphragm for electroacoustic transducers which comprises a core layer comprising poly(meth)acrylimide foam and at least one covering layer, which process can be carried out in a simple way. In particular, it allows the production of the shaped diaphragms at significantly shorter cycle times.

The following advantages, in particular, are among those achieved by means of the process of the invention:

In the process of the invention, the covering layer is applied particularly firmly to the core layer so that it does not become detached from the core layer even after prolonged use.

The process of the invention makes it possible to use, inter alia, covering layers which do not have a fibrous structure.

The desired strength of the component can be set within a wide range via the degree of compaction of the core layer in combination with the choice of the covering layer.

The process of the invention can be employed for producing shaped diaphragms for electroacoustic transducers. These diaphragms are preferably curved and are advantageously in the form of a hollow body. According to the invention, the process has been found to be very particularly useful for producing conical diaphragms, in particular truncated conical diaphragms.

To produce the shaped diaphragms, the covering layer is firstly laminated with the core layer at a temperature of ≧160° C., preferably in the range 165-230° C., in particular in the range 180-195° C. Lamination is preferably carried out by lightly pressing together the composite, but the applied pressure should be less than 0.3 MPa. The applied pressure is advantageously from 0.05 to 0.25 MPa. The duration of the lamination step is determined, inter alia, by the curing conditions for the adhesive. It is preferably from 0.01 to 10 minutes, in particular from 0.1 to 5 minutes.

After lamination, the composite obtained is molded at a pressure of ≧0.3 MPa, preferably in the range 1-16 MPa, and a temperature of ≧160° C., preferably in the range 175-200° C., advantageously in the range 180-200° C., in particular in the range 180-195° C., using a cold mold which is at a temperature of less than 100° C., and at the same time at least the side of the core layer which is in contact with the covering layer is compacted. This can in general be achieved by hot forming processes as described, for example, in Dubbel, Taschenbuch für den Maschinenbau, 19th edition, edited by W. Beitz and K.-H. Grote, Springer 1997, E77. In hot forming, the thermoplastic semifinished part (composite from a)) is quickly and uniformly heated to the temperature at which the thermoplastic behavior is optimum and molded by means of vacuum, compressed air or mechanical forces and fixed by cooling.

For the purposes of the present invention, it has been found to be very particularly advantageous to insert the laminated composite from a) between a positive and a negative and then bring it to the desired shape by pressing together the tool. Cooled spacers, also known as stops, are preferably employed where appropriate in the pressing step. These make it easier to set a desired degree of compaction of the core layer, but the invention is not restricted to their use.

To prevent the compacted cells from returning to their original shape after opening of the press, molds which have been cooled to less than 100° C. are, according to the invention, used in substep b). This considerably shortens the cycle time of the process, because the composite produced can be taken directly from the press without the latter firstly having to be cooled to a temperature of <100° C. Particularly advantageous results are obtained when using cooled molds which are at a temperature of less than 90° C., preferably less than 80° C., in particular less than 70° C.

Preferred embodiments of the diaphragm of the invention have two covering layers which together with the core layer form a sandwich structure. The production of such diaphragms will now be described with the aid of the following figures.

The figures show:

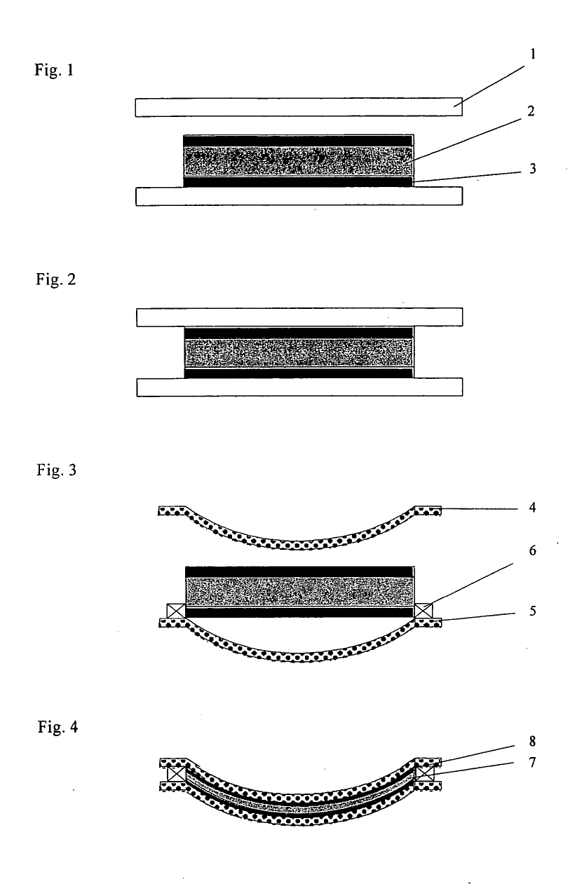

FIG. 1: placing the covering layers and the core layer in a first press,

FIG. 2: heating to lamination temperature and closing to contact

FIG. 3: introducing the laminated composite into a second press with positive and negative

FIG. 4: closing the second press at compaction temperature.

Figures FIGS. 1 to 4 schematically show the production of the diaphragm of the invention. Firstly, the core layer (2) of poly(meth)acrylimide foam together with the covering layers (3) located on both sides is placed in a first press which has heatable and coolable platens (1). This procedure can be carried out at a temperature of less than 80° C.

The press is subsequently closed to contact, which is shown in FIG. 2. At this time, the temperature of the press is increased to the lamination temperature. The lamination temperature is at least 160° C., preferably in a range of 165-230° C., very particularly preferably in a range of 180-195° C. If the temperature is less than 160° C., damage to the pore structure of the rigid poly(meth)acrylimide foam can occur.

The pressure employed for this purpose is less than 0.3 MPa, preferably from 0.01 to <0.3 MPa, in particular from 0.05 to 0.25 MPa.

After a first residence time t₁, which is preferably from 0.01 to 10 minutes, the laminated composite is introduced at a temperature of ≧160° C., preferably in the range 175-200° C., advantageously in the range 180-200° C., in particular in the range 180-195° C., into a second press which is provided with a positive (mold, 4) cooled to less than 100° C., preferably less than 90° C., advantageously less than 80° C., in particular less than 70° C., and a negative (countermold, 5) which has been cooled to less than 100° C., preferably less than 90° C., advantageously less than 80° C., in particular less than 70° C. (cf. FIG. 3). The press is closed to the stops (6), which may likewise be cooled, as is shown in FIG. 4. In this way, the core layer is compacted to the intended degree of compaction. This is indicated by the reference numeral 7. The pressure required for this purpose is generally at least 0.3 MPa. However, it is also possible to choose a higher pressure, advantageously a pressure in the range from 1 to 16 MPa. The residence time in the second press is generally very short. It is preferably from 5 to 300 seconds, in particular from 10 to 30 seconds.

In the process of the invention, the core layer is preferably compacted to a thickness less than 90%, preferably less than 80%, of the original thickness. If the compaction is less than this, the lamination does not adhere sufficiently in many cases without the use of particular adhesives. Compaction means that the pores of the core layer are made smaller. As a result, the strength of the diaphragm is considerably increased without its suitability for use as electroacoustic transducer being significantly impaired thereby.

The core layers relevant to the process of the invention comprise poly(meth)acrylimide foam. The notation (meth)acryl . . . encompasses methacryl . . . , acryl and mixtures of the two.

Poly(meth)acrylimide foams for core layers of diaphragms comprise repeating units which can be represented by the formula (I),

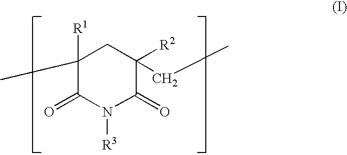

where

R¹ and R² are identical or different and are each hydrogen or a methyl group and

R³ is hydrogen or an alkyl or aryl radical having up to 20 carbon atoms, with hydrogen being preferred.

Units of the structure (I) preferably make up more than 30% by weight, particularly preferably more than 50% by weight and very particularly preferably more than 80% by weight, of the poly(meth)acrylimide foam.

The production of rigid poly(meth)acrylimide foams which can be used according to the invention is known and is disclosed in, for example, GB-B 1 078 425 and 1 045 229, DE-C 1 817 156 (=U.S. Pat. No. 3,627,711) or DE-C 27 26 259 (=U.S. Pat. No. 4,139,685).

Thus, the units of the structural formula (I) can be formed, inter alia, from adjacent units of (meth)acrylic acid and (meth)acrylonitrile by a cyclizing isomerization reaction on heating to from 150 to 250° C. (cf. DE-C 18 17 156, DE-C 28 26 259, EP-B 146 892). Usually, an intermediate is firstly produced by polymerization of the monomers in the presence of a free-radical initiator at low temperatures, e.g. from 30 to 60° C. with subsequent heating to from 60 to 120° C., and this is then foamed by heating to from about 180 to 250° C. in the presence of a blowing agent (cf. EP-B 356 714).

For example, a copolymer comprising (meth)acrylic acid and (meth)acrylonitrile, preferably in a molar ratio of from 2:3 and 3:2, can firstly be formed for this purpose.

In addition, these copolymers can further comprise additional comonomers, for example esters of acrylic or methacrylic acid, in particular with lower alcohols having 1-4 carbon atoms, styrene, maleic acid or its anhydride, itaconic acid or its anhydride, vinylpyrrolidone, vinyl chloride or vinylidene chloride. The proportion of comonomers which cannot be cyclized or can be cyclized only with great difficulty should not exceed 30% by weight, preferably 10% by weight.

In a likewise known manner, small amounts of crosslinkers, e.g. allyl acrylate, allyl methacrylate, ethylene glycol diacrylate or dimethacrylate, or polyvalent metal salts of acrylic or methacrylic acid, e.g. magnesium methacrylate, can advantageously be used as further monomers. The proportions can be, for example, from 0.005 to 5% by weight.

Furthermore, the intermediates may further comprise customary additives. These include, inter alia, antistatics, antioxidants, mold release agents, flame retardants, lubricants, dyes, flow improvers, fillers, light stabilizers and organic phosphorus compounds such as phosphites or phosphonates, pigments, weathering inhibitors and plasticizers.

Polymerization initiators employed are those customary for the polymerization of methacrylates, for example azo compounds such as azobisisobutyronitrile, and also peroxides such as dibenzoyl peroxide or dilauroyl peroxide, or else other peroxide compounds, e.g. t-butyl peroctanoate or perketals, as well as, if desired, redox initiators (cf., for example, H. Rauch-Puntigam, Th. Völker, Acryl- und Methacrylverbindungen, Springer, Heidelberg, 1967, or Kirk-Othmer, Encyclopedia of Chemical Technology, Vol. 1, pages 286 ff, John Wiley & Sons, New York, 1978). The polymerization initiators are preferably used in amounts of from 0.01 to 0.3% by weight, based on the starting materials. It can also be useful to combine polymerization initiators having different decomposition properties in terms of time and temperature. For example, the simultaneous use of tert-butyl perpivalate, tert-butyl perbenzoate and tert-butyl per-2-ethylhexanoate is advantageous.

Foaming of the copolymer during conversion into a polymer containing imide groups is achieved in a known manner by use of blowing agents which form a gas phase at from 150 to 250° C. by decomposition or vaporization. Blowing agents having an amide structure, e.g. urea, monomethyl urea or N,N′-dimethylurea, formamide or monomethyl formamide, decompose with liberation of ammonia or amines which can contribute to additional formation of imide groups. However, it is also possible to use nitrogen-free blowing agents such as formic acid, water or monohydric aliphatic alcohols having from 3 to 8 carbon atoms, e.g. propanol, butanol, isobutanol, pentanols or hexanols. Blowing agents are usually used in the reaction mixture in amounts of about 0.5 to 8% by weight, based on the monomers used.

A very particularly preferred polymethacrylimide foam which can be used can be obtained, for example, by means of the following steps:

1. Production of a polymer sheet by free-radical polymerization in the presence of one or more initiators and, if desired, further customary additives as mentioned above by way of example, comprising

(a) a monomer mixture of 40-60% by weight of methacrylonitrile, 60-40% by weight of methacrylic acid and, if desired, up to 20% by weight, based on the sum of methacrylic acid and methacrylonitrile, of further monofunctional, vinylically unsaturated monomers,

(b) 0.5-8% by weight of a blowing agent mixture comprising formamide or monomethylformamide and a monohydric aliphatic alcohol having 3-8 carbon atoms in the molecule,

(c) a crosslinker system comprising

(c.1) 0.005-5% by weight of a free-radically polymerizable vinylically unsaturated compound having at least 2 double bonds in the molecule and

(c.2) 1-5% by weight of magnesium oxide dissolved in the monomer mixture.

2. Foaming of the sheet at temperatures of from 200 to 260° C. to give a polymethacrylimide sheet, and subsequent

3. heat treatment in two steps, with the first step being at 100-130° C. for 2-6 hours and the second step being at 180-220° C. for 32-64 hours.

Polymethacrylimides having a high heat distortion resistance can also be obtained by reacting polymethyl methacrylate or its copolymers with primary amines, which can likewise be used according to the invention. Representatives of the many examples of this polymer-analogous imidation are: U.S. Pat. No. 4,246,374, EP 216 505 A2, EP 860 821. High heat distortion resistance can here be achieved either by use of arylamines (JP 05222119 A2) or by the use of specific comonomers (EP 561 230 A2, EP 577 002 Al). However, all these reactions do not give foams but solid polymers which have to be foamed in a separate, second step to obtain a foam. Techniques for this are also known from the prior art.

Rigid poly(meth)acrylimide foams can also be obtained commercially, for example ®Rohacell from Röhm GmbH, which can be supplied in various densities and sizes.

The density of the poly(meth)acrylimide foam before compaction is preferably in the range from 20 kg/m³ to 180 kg/m³ , particularly preferably in the range from 30 to 110 kg/m³.

The core layer may further comprise additional layers. Prior to compaction, the thickness of the core layer is in the range from 0.8 to 100 mm, in particular in the range from 1 to 15 mm and very particularly preferably in the range from 1 to 8 mm.

As covering layer it is possible to use any known sheet-like body which is stable at the processing parameters, e.g. pressure and temperature, necessary for producing the diaphragm and can be molded at a temperature of ≧160° C., preferably 175-200° C., advantageously in the range 180-200° C., in particular in the range 180-195° C. Here, the term “sheet-like body which can be molded” refers, for the purposes of the present invention, to sheet-like bodies which can be plastically deformed by means of mechanical forces. In this context, sheet-like bodies which can be molded, preferably hot formed, at a temperature of ≧160° C., preferably 175-200° C., advantageously in the range 180-200° C., in particular in the range 180-195° C., under a pressure of ≧0.3 MPa, in particular in the range from 1 to 16 MPa, have been found to be particularly advantageous.

The sheet-like bodies which are preferred according to the invention include, for example, films or sheets [lacuna] polymers which can be molded at a temperature of ≧160° C., preferably 175-200° C., advantageously in the range 180-200° C., in particular in the range 180-195° C., advantageously moldable polyesters and polyamides, in particular polyamides. The polymers preferably have a glass transition temperature of less than 160° C. and a melting point of greater than 160° C., preferably greater than 170° C., advantageously greater than 180° C. Here, both the glass transition temperature and the melting point are determined by means of DSC using a heating rate of 20° C./min. Blends of a plurality of polymers and/or the use of copolymers are also conceivable. Films/sheets comprising polyamide-12, in particular the ®Vestamid L1600 obtainable from Degussa-Huels AG/Creanova Inc., have been found to be very particularly useful for the purposes of the invention. Here, the proportion by weight of the moldable polymer or polymers based on the total weight of the film/sheet is preferably at least 50% by weight, advantageously at least 65% by weight, particularly preferably at least 80% by weight, in particular at least 95% by weight.

Furthermore, the use of mats or sheets comprising glass fibers, carbon fibers and/or aramid fibers is also preferred, as long as these sheets or mats can be molded at a temperature of ≧160° C., preferably 175-200° C., advantageously in the range 180-200° C., in particular in the range 180-195° C. It is also possible to use sheets having a multilayer structure as covering layer. According to the invention, particular preference is given to sheets, usually glass fiber mats or woven fabrics made of glass filaments, which have been preimpregnated with curable resins and can be processed by hot pressing to produce moldings or semifinished parts. Here, the curable resin is preferably a polymer which can be molded at a temperature of ≧160° C., preferably 175-200° C., advantageously in the range 180-200° C., in particular in the range 180-195° C., preferably a polyester or a polyamide, in particular a polyamide. The polymer preferably has a glass transition temperature of less than 160° C. and a melting point of greater than 160° C., preferably greater than 170° C., advantageously greater than 180° C., particularly preferably greater than or equal to 190° C., in particular in the range 190-230° C. Both the glass transition temperature and the melting point are determined by means of DSC using a heating rate of 20° C./min. Blends of a plurality of polymers and/or the use of copolymers are also conceivable. Semifinished parts comprising polyamide-12, in particular the ®Vestamid L1600 obtainable from Degussa-Huels AG/Creanova Inc., have been found to be very particularly useful for the purposes of the invention. The proportion by weight of the moldable polymer or polymers based on the total weight of the film/sheet is preferably at least 50% by weight, advantageously at least 65% by weight, particularly preferably at least 80% by weight, in particular at least 95% by weight.

The thickness of the covering layer is preferably in the range from 0.05 to 10 mm, preferably in the range from 0.1 to 5 mm and very particularly preferably in the range from 0.5 to 2 mm.

To improve the adhesion, it is also possible to use an adhesive. However, depending on the material of the covering layer, this may not be necessary.

The diaphragm produced by the process of the invention have excellent mechanical properties. Thus, for example, the peel strength in accordance with DIN 53295 is 10 N/mm or more, preferably more than 15 N/mm. The modulus of elasticity in accordance with DIN 53 423 is greater than or equal to 50 MPa, in particular greater than 60 MPa.

Furthermore, the flexural strength in accordance with DIN 53423 is also surprisingly high, being 2 MPa or more, in particular greater than 2.3 MPa. The flexural stiffness in accordance with DIN 53 293, too, is 8 MPa or more, in particular greater than 10 MPa.

Possible fields of application of the shaped diaphragms of the invention will be self-evident to a person skilled in the art. The diaphragms are preferably used as diaphragms for electroacoustic transducers, in particular as loudspeaker diaphragms.

1. A process for producing a shaped diaphragm for electroacoustic transducers which comprises a core layer comprising poly(meth)acrylimide foam and at least one covering layer, wherein
a) the covering layer is laminated with the core layer under a pressure of <0.3 MPa and at a temperature of ≧160° C., and
b) the resulting composite is subsequently molded at a pressure of ≧0.3 MPa and a temperature of ≧160° C. using a cold mold which is at a temperature of less than 100° C. and at least the side of the core layer which is in contact with the covering layer is compacted at the same time.

2. The process as claimed in claim 1, wherein in the lamination procedure at least the side of the core layer which is in contact with the covering layer is heated to a temperature in the range from 165 to 230° C., in particular in the range from 180 to 195° C.

3. The process as claimed n claim 1 wherein a temperature in the range 175-200° C., preferably in the range 180-200° C., in particular in the range from 180 to 195° C., is set for the molding procedure.

4. The process as claimed in claim 1, wherein the molding procedure is carried out using a pressure in the range from 1 to 16 MPa.

5. The process as claimed in claim 1, wherein the core layer is compacted to a thickness of less than 90% of the original thickness.

6. The process as claimed in claim 1, wherein a core layer comprising poly(meth)acrylimide foam is used.

7. The process as claimed in claim 1, wherein a sheet-like body which comprises a thermoplastically processable polymer and can be molded at a temperature of ≧160° C., preferably 175-200° C., advantageously in the range 180-200° C., in particular in the range 180-195° C., is used as covering layer.

8. The process as claimed in claim 1, wherein a sheet-like semifinished part comprising polyamide-12 is used as covering layer.

9. The process as claimed in claim 1, wherein two covering layers are used so as to obtain a sandwich structure.

10. A shaped diaphragm for electroacoustic transducers which comprises a core layer comprising poly(meth)acrylimide foam and at least one covering layer, wherein the covering layer is a sheet-like body which comprises a thermoplastically processable polymer and can be molded at a temperature of ≧160° C., preferably 175-200° C., advantageously in the range 180-200° C., in particular in the range 180-195° C.

11. A shaped diaphragm as claimed in claim 10, wherein the peel strength is ≧10 N/mm, the modulus of elasticity is ≧50 MPa and the flexural strength is ≧2 MPa.

12. A shaped diaphragm as claimed in claim 10, wherein the diaphragm has two covering layers.

13. A shaped diaphragm as claimed in claim 10, wherein the diaphragm has a conical shape, preferably a truncated conical shape.

14. The use of a shaped diaphragm as claimed in claim 10 as an electroacoustic transducer, preferably as a loudspeaker diaphragm.
